(19) United States
(12) Patent Application Publication
(10) Pub. No.: US 2010/0206610 A1
(43) Pub. Date: Aug. 19, 2010

(54) SHIELDED WIRE

(75) Inventor: Daisuke YAGI, Susono-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/650,595

(22) Filed: Dec. 31, 2009

(30) Foreign Application Priority Data
Feb. 13, 2009 (JP) 2009-031764

(51) Int. Cl. H01B 9/02

(52) U.S. Cl. 174/106 R

(57) ABSTRACT

A shielded wire includes an internal conductor, an insulating layer covering the internal conductor, a shielding layer covering the insulating layer, and a protective layer covering the shielding layer. The shielding layer includes a first electromagnetic shielding layer and a second electromagnetic shielding layer which is directly provided on an outside of the first electromagnetic shielding layer. The first electromagnetic shielding layer has at least one of a metal braid and a metal foil, and the second electromagnetic shielding layer has a conductive resin.

### BACKGROUND

The present invention relates to a shielded wire which is mainly suitable for wiring from a stationary part to a movable part of a vehicle.

For example, as shown in FIG. 4, a shielded wire such as a single-core shielded wire includes an internal conductor 101, an insulating layer 102 (dielectric layer) covering the outside of the internal conductor 101, a shielding layer 103 surrounding the outside of the insulating layer 102 and a protective layer 105 (outer sheath) covering the outside of the shielding layer 103.

General kinds of shielded wires are a braid shielded wire in which a shielding layer has a metal braid, foil shielded wire in which a shielding layer has a metal foil (for example, an aluminum foil, a copper foil, etc.), and a foil/braid shielded wire in which a shielding layer has both of a metal braid and a metal foil.

The braid shielded wire has a structure in which an insulating layer (dielectric layer) covers an internal conductor, a metal braid serving as an electromagnetic shielding layer is braided on the outside of the insulating layer, and a protective layer is provided as an outermost layer. The foil shielded wire has a structure in which an insulating layer covers an internal conductor, a film serving as an electromagnetic shielding layer is wound around the outside of the insulating layer, and a protective layer is provided as an outermost layer. The foil/braid shielded wire is constituted into a layered structure by bringing the metal braid and the metal foil into contact with each other or insulating them from each other. In the case where a metal foil is used as the electromagnetic shielding layer, it is general that a film formed by laminating both a resin, for example, PET and a metal foil is wound around the insulating layer covering the internal conductor.

Also, as shown in FIG. 5A, Patent Document 1 discloses a shielded wire having a structure in which a conductive core wire 201 (conductor covered by an insulating material) is covered by an electromagnetic shielding layer 210 composed of a laminated film which is constituted by laminating a thermoplastic resin layer 203 on the outside of an aluminum foil 202 and laminating a carbon material-containing conductive resin layer 204 on the inside of the aluminum foil 202, and a protective layer 205 is provided on the outside of the electromagnetic shielding layer 210. In FIG. 5A, a reference number 208 represents a drain wire, and the drain wire is disposed in the inside of the electromagnetic shielding layer 210. FIG. 5B is a sectional view of the laminated film constituting the electromagnetic shielding layer 210, and an adhesive layer 206 for achieving adhesion to the protective layer 205 is provided on the outer face of the electromagnetic shielding layer 210.

In that case, the conductive resin layer 204 works to protect the aluminum foil 202 from oxidation or corrosion, thereby enhancing its salt resistance. Also, the conductive resin layer 204 surely comes into contact with the drain wire 208, and therefore, even in the case where bending or vibration is given, it works to not impair the continuity between the drain wire 208 and the aluminum foil 202.

[Patent Document 1] JP-A-7-105748

Meanwhile, in a vehicle, in the case of wiring a shielded wire in a movable part such as a sheet and a door from a body (stationary part), a load such as bending and twist to a part of the shielded wire at every mechanical movement. For that reason, there is involved such a problem that breaking of wire is generated in a strand constituting a metal braid, or a crack is generated in a metal foil due to bending or twist, and its damage is advanced to cause an increase in resistance (lowering in conductivity) of an electromagnetic shielding layer, whereby a pass characteristic or a shield characteristic in the shielded wire is deteriorated.

In this respect, in the shielded wire disclosed in Patent Document 1, since the conductive resin layer 204 is provided on the inner peripheral side of the aluminum foil, the conductive resin layer 204 compensates influences of the damage of the aluminum foil to some extent. However, a portion where a defect is caused has not been thoroughly complemented yet by the conductive resin layer 204.

### SUMMARY

In view of the above circumstances, the invention has been made, and its object is to provide a shielded wire which even when the number of bending or twist increases, is low in deterioration of performances (deterioration in a pass characteristic or a shield characteristic).

In order to achieve the above object, the shielded wire according to the invention comprising;

an internal conductor;

an insulating layer covering the internal conductor;

a shielding layer covering the insulating layer; and

a protective layer covering the shielding layer,

wherein the shielding layer includes a first electromagnetic shielding layer and a second electromagnetic shielding layer which is directly provided on an outside of the first electromagnetic shielding layer; and

wherein the first electromagnetic shielding layer has at least one of a metal braid and a metal foil, and the second electromagnetic shielding layer has a conductive resin.

Preferably, the conductive resin of the second electromagnetic shielding layer comes into directly contact with the metal braid or the metal foil included in the first electromagnetic shielding layer.

Preferably, the first electromagnetic shielding layer is composed of the metal foil. The shielding layer has a laminated film shape in which the metal foil is overlapped on the conductive resin of the second electromagnetic shielding layer, and the shielding layer is wound around the insulating layer.

Preferably, the second electromagnetic shielding layer is arranged between the first electromagnetic shielding layer and the protective layer.

According to the above configurations, even when a crack is generated in the metal foil of the first electromagnetic shielding layer, or breaking of wire is generated in a strand of the metal braid due to repeated bending or twist, the subject defective portion can be compensated by the conductive resin constituting the second electromagnetic shielding layer, and therefore, a lowering in conductivity (increase in resistance) of the shielding layer can be avoided, and significant deterioration of a passing characteristic or a shield characteristic as a shielded wire can be prevented from occurring. In consequence, it becomes possible to provide a shielded wire for vehicles which is capable of being wired in a site with a high bending number. In particular, since the second electromagnetic shielding layer having a conductive resin is provided so as to come into intimate contact with the outside of the metal braid or metal foil of the first electromagnetic shielding layer, the outer peripheral side of the metal foil or metal braid where a crack or breaking of wire is easily generated (a crack or breaking of wire is easily generated from the outer peripheral side where expansion and contraction are large at the time of bending) can be complemented directly by the conductive resin even at the time when a defect is caused, and deterioration of a shield performance can be effectively suppressed.

Also, since the film formed by laminating the conductive resin on the metal foil is wound, thereby adding the second electromagnetic shielding layer having the conductive resin, similar to the time when a metal foil is wound as in the related art, the shielding layer can be made only by winding the laminated film, thereby saving a load of the manufacturing steps. Also, since the metal foil is used for the electromagnetic shielding layer, as compared with the case of using a metal braid, not only such a constitution is able to contrive to reduce the metal materials, but it is advantageous in reduction in size and weight of a wire.

According to the shielded wire of the invention, even when used in an area to which repeated bending or twist is applied, sufficient performances can be revealed as a shielded wire.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a sectional view of a shielded wire of a first embodiment of the invention;

FIG. 2A is a sectional view as well as a plane view of a laminated film to be used for the shielded wire according to the first embodiment;

FIG. 2B is a sectional view as well as a plane view showing a modification example of the laminated film of FIG. 2A;

FIG. 3 is a sectional view of a shielded wire according to a second embodiment of the invention;

FIG. 4 is a sectional view showing an example of a related-art shielded wire;

FIG. 5A is a sectional view showing another example of a related-art shielded wire; and

FIG. 5B is a sectional view of a film to be used for the related-art shielded wire.

### DETAILED DESCRIPTION OF EXEMPLARY EMBODIMENTS

Embodiments of the invention are hereunder described with reference to the accompanying drawings.

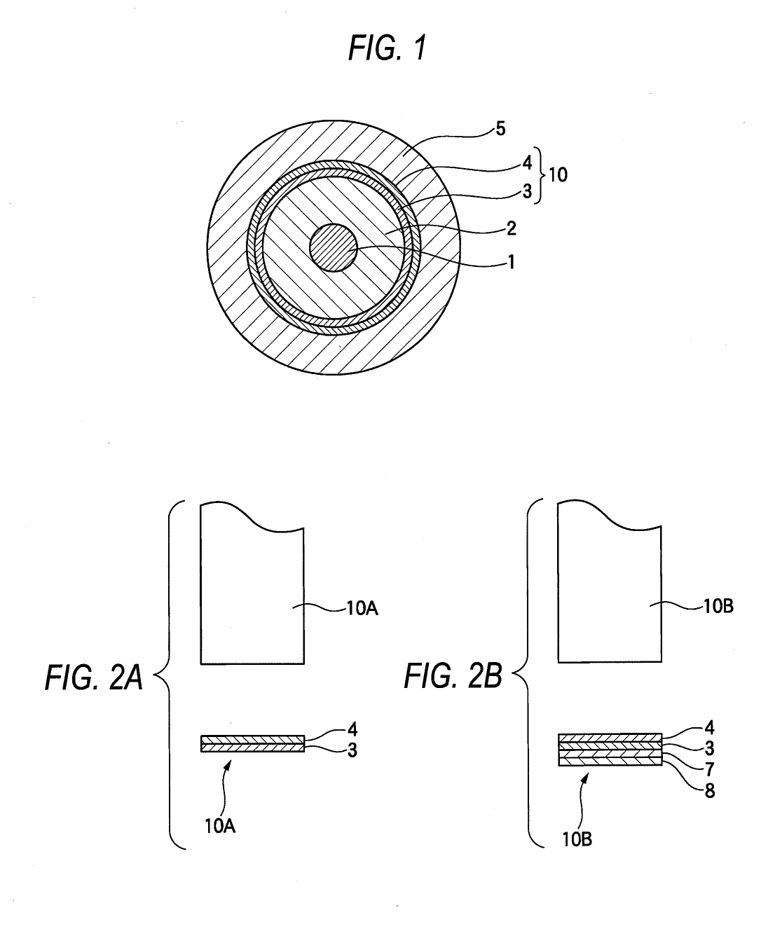

FIG. 1 is a sectional view of a single-core shielded wire according to a first embodiment of the present invention.

This shielded wire has an internal conductor 1, an insulating layer 2 (dielectric layer) covering the outside of the internal conductor 1, a shielding layer 10 surrounding the outside of the insulating layer 2 and a protective layer 5 covering the outside of the shielding layer 10. This shielded layer is characterized in that the shielding layer 10 is constituted into a two-layered structure of a first electromagnetic shielding layer 3A having a metal foil of aluminum, copper, etc. and a second electromagnetic shielding layer 4 having a conductive resin, which is provided on the outside of the first electromagnetic shielding layer 3A so as to come into directly contact with the metal foil of the first electromagnetic shielding layer 3A.

The second electromagnetic shielding layer 4 having a conductive resin is a layer made of a film-shaped material having conductivity and flexibility. The conductive resin has a metal power or a carbon material and so on.

In the case of making the shielded wire, as shown in FIG. 2A, a laminated film 10A formed by laminating a metal foil constituting the first electromagnetic shielding layer 3A and a conductive resin constituting the second electromagnetic shielding layer 4 is helically wound around the insulating layer 2, thereby forming the shielding layer 10. Alternatively, as shown in FIG. 2B, a laminated film 10B formed by laminating a thermoplastic resin layer 7 such as PET and an adhesive layer 8 on the inner face side of the metal foil constituting the first electromagnetic shielding layer 3A is helically wound around the insulating layer 2, thereby forming the shielded layer 10.

In the case where the second electromagnetic shielding layer 4 having a conductive resin is laminated on the outside of the first electromagnetic shielding layer 3A having a metal foil in this way, even when a crack is generated in the metal foil of the first electromagnetic shielding layer 3A due to repeated bending, the subject defective portion can be compensated by the conductive resin constituting the second electromagnetic shielding layer 4, and therefore, a lowering in conductivity (increase in resistance) of the shielding layer 10 can be avoided, and significant deterioration of a passing characteristic or a shield characteristic as a shielded wire can be prevented from occurring. In consequence, it becomes possible to provide a shielded wire for vehicles which is capable of being wired in a site with a high bending number. In particular, in the case of this shielded wire, since the second electromagnetic shielding layer 4 having a conductive resin is provided so as to come into directly contact with the outside of the metal foil of the first electromagnetic shielding layer 3A, the outer peripheral side of the metal foil where a crack is easily generated can be complemented directly by the conductive resin even at the time when a defect is caused, and deterioration of a shield performance can be effectively suppressed.

Also, in this shielded wire, since the laminated film 10A or 10B formed by laminating the conductive resin on the metal foil is wound, thereby adding the second electromagnetic shielding layer 4 having a conductive resin, similar to the time when a metal foil is wound as in the related art, the shielding layer 10 can be made only by winding the laminated film, thereby saving a load of the manufacturing steps. Also, since the metal foil is used for the first electromagnetic shielding layer 3A, as compared with the case of using a metal braid as in a second embodiment as described later, not only it is possible to contrive to reduce the metal materials, but it is advantageous in reduction in size and weight of a wire.

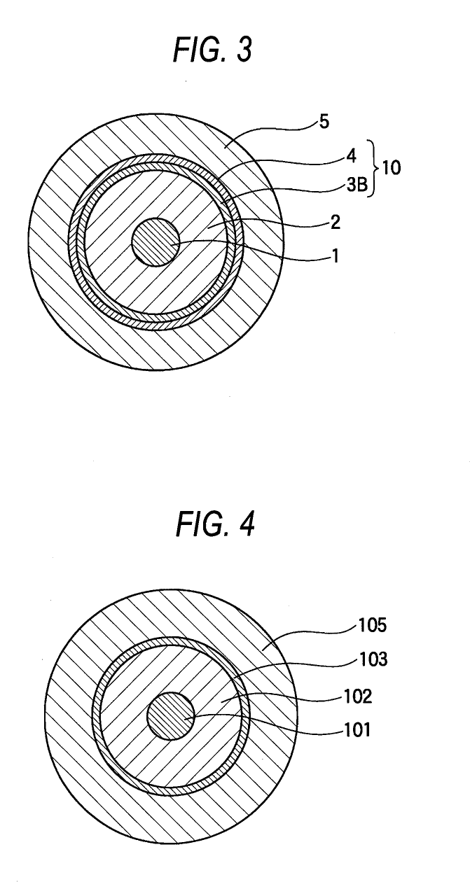

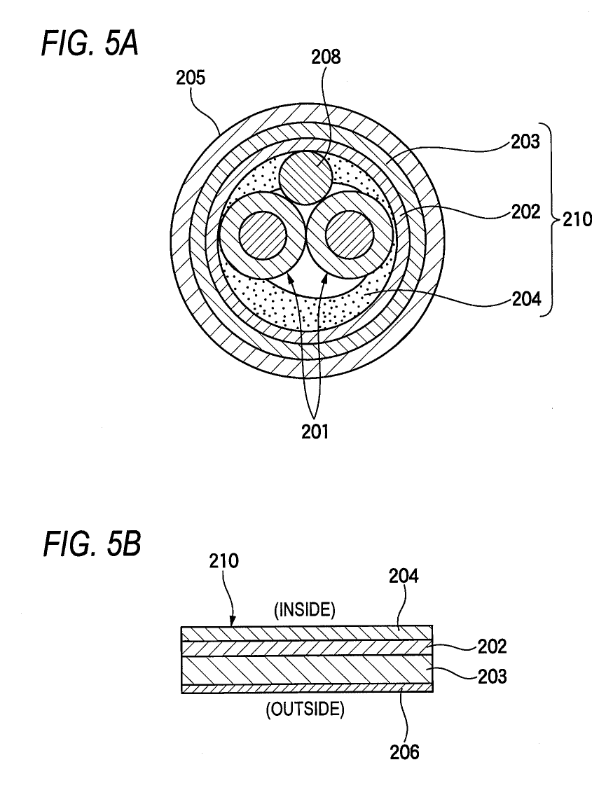

FIG. 3 is a sectional view of a single-core shielded wire which is shown as a second embodiment.

This shielded wire has an internal conductor 1, an insulating layer 2 (dielectric layer) covering the outside of the internal conductor 1, a shielding layer 11 surrounding the outside of the insulating layer 2 and a protective layer 5 covering the outside of the shielding layer 11. This shielded layer is characterized in that the shielding layer 11 is constituted into a two-layered structure of a first electromagnetic shielding layer 3B having a metal braid of aluminum, copper, etc. and a second electromagnetic shielding layer 4 having a conductive resin, which is provided on the outside of the first electromagnetic shielding layer 3B so as to come into directly contact with the metal braid of the first electromagnetic shielding layer 3B.

The second electromagnetic shielding layer 4 having a conductive resin is a layer made of a film-shaped material having conductivity and flexibility; and as the conductive resins, resins containing a metal power or resins having a carbon material can be employed.

In the case of making this shielded wire, the metal braid constituting the first electromagnetic shielding layer 3B is braided on the outside of the insulating layer 2, and the second electromagnetic shielding layer 4 having a conductive resin is then formed thereon, thereby forming the shielding layer 11.

In the case where the second electromagnetic shielding layer 4 having a conductive resin is laminated on the outside of the first electromagnetic shielding layer 3B having a metal braid in this way, even when breaking of wire is generated in a strand of the metal braid of the first electromagnetic shielding layer 3B due to repeated bending, the subject defective portion can be compensated by the conductive resin constituting the second electromagnetic shielding layer 4, and therefore, a lowering in conductivity (increase in resistance) of the shielding layer 11 can be avoided, and significant deterioration of a passing characteristic or a shield characteristic as a shielded wire can be prevented from occurring. In consequence, it becomes possible to provide a shielded wire for vehicles which is capable of being wired in a site with a high bending number. In particular, in the case of this shielded wire, since the second electromagnetic shielding layer 4 having a conductive resin is provided so as to come into directly contact with the outside of the metal braid of the first electromagnetic shielding layer 3B, the outer peripheral side of the metal braid where a crack is easily generated can be complemented directly by the conductive resin even at the time when a defect is caused, and deterioration of a shield performance can be effectively suppressed.

Also, in this shielded wire, the first electromagnetic shielding layer 3B is constituted of a metal braid, and therefore, it is able to reveal a stronger performance than that of the shielded wire using a metal foil according to the first embodiment.

It should not be construed that the invention is limited to the above embodiments, and deformation, improvement and the like can be properly made. Besides, the quality, shape, size, number, disposition area and the like of each of the constitutional elements in the embodiments are arbitrary and not limitative so far as the invention can be achieved.

For example, in the above embodiments, while the case where the first electromagnetic shielding layer is constituted of a metal foil or a metal braid has been described, the first electromagnetic shielding layer may be constituted of both a metal foil and a metal braid.

Also, in the above embodiments, while the single-core shielded wire has been described, the invention can be applied to a shielded wire having plural cores. Also, the invention can be widely applied to composite wires such as coaxial wires, multi-core shielded wires and IEEE1394 wires (according to the high-speed serial bus standards for connecting an AV appliance or a computer).

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2009-031764 filed on Feb. 13, 2009, the contents of which are incorporated herein for reference.

What is claimed is:

1. A shielded wire comprising;
an internal conductor;
an insulating layer covering the internal conductor;
a shielding layer covering the insulating layer; and
a protective layer covering the shielding layer,
wherein the shielding layer includes a first electromagnetic shielding layer and a second electromagnetic shielding layer which is directly provided on an outside of the first electromagnetic shielding layer; and
wherein the first electromagnetic shielding layer has at least one of a metal braid and a metal foil, and the second electromagnetic shielding layer has a conductive resin.

2. The shielded wire according to claim 1, wherein the conductive resin of the second electromagnetic shielding layer comes into directly contact with the metal braid or the metal foil included in the first electromagnetic shielding layer.

3. The shielded wire according to claim 1, wherein the first electromagnetic shielding layer is composed of the metal foil; and
wherein the shielding layer has a laminated film shape in which the metal foil is overlapped on the conductive resin of the second electromagnetic shielding layer, and the shielding layer is wound around the insulating layer.

4. The shielded wire according to claim 1, wherein the second electromagnetic shielding layer is arranged between the first electromagnetic shielding layer and the protective layer.
